(19) United States
(12) Patent Application Publication
(10) Pub. No.: US 2016/0163238 A1
(43) Pub. Date: Jun. 9, 2016

(54) METHOD OF ADVERTISING

(71) Applicant: Edward Scott KRAUSE, Itasca, IL (US)

(72) Inventor: Edward Scott KRAUSE, Itasca, IL (US)

(21) Appl. No.: 15/042,497

(22) Filed: Feb. 12, 2016

Related U.S. Application Data
(63) Continuation-in-part of application No. 14/641,792, filed on Mar. 9, 2015.
(60) Provisional application No. 61/950,044, filed on Mar. 8, 2014.

(51) Int. Cl. G09F 3/10; B65D 33/00; G06Q 90/00

(52) U.S. Cl. CPC G09F 3/10; G06Q 90/00; B65D 33/004

(57) ABSTRACT

A method for advertising using removably attachable note sheets that facilitate acknowledgement of the message contained thereon is provided. The note sheets may have at least one predetermined messages affixed thereto or be blank so that a user may spontaneously affix at least one desired message thereto, whereby the user may present potential consumers with the note sheets in such a manner and with such a message so as to encourage interaction with and acknowledgement of the at least one message by the potential consumer.

### CROSS-REFERENCE TO RELATED APPLICATION

This application is a continuation-in-part of a non-provisional application Ser. No. 14/641,792, filed 9 Mar. 2015, which claims the benefit of priority of U.S. provisional application No. 61/950,044, filed 8 Mar. 2014, the contents of which are herein incorporated by reference.

### BACKGROUND OF THE INVENTION

The present invention relates to methods of advertising and, more particularly, to a method of advertising using a removably attachable notes.

Current methods of advertising to in-store clientele typically involves pushing a handout onto the potential customer and/or, for potential repeat customers, stuffing promotional material inside the packaging of a purchased good or service. Both are usually quickly discarded because of the played-out nature of the method, and, in the case of the latter, may never be seen.

Not only are these current methods ineffectual, they are inefficient for the employee to employ. They are also self-frustrating because their imaginatively bankrupt nature encourages potential customers to discarded or never acknowledge such solicitations as the empty gestures they are.

As can be seen, there is a need for a method of advertising using a removably attachable notes that facilitates acknowledgement of the message contained thereon by, in certain instances, being employed on the exterior surface of objects.

### SUMMARY OF THE INVENTION

In one aspect of the present invention, a method for advertising so as to facilitate interaction and acknowledgement by a potential customer includes providing at least one note sheet having an adhesive disposed along a portion thereof; affixing a predetermined message on the at least one note sheet; and attaching the adhesive to an object of a potential customer so as to facilitate the potential customer's acknowledgement of the predetermined message when using the object.

In another aspect of the present invention, a method for advertising so as to facilitate interaction and acknowledgement by a potential customer includes providing to an agent at least one note sheet having an adhesive disposed along a portion thereof; providing a note pad wherein the at least one note sheet is removably bound to a plurality of note sheets; providing a dispenser for removably housing the note pad; affixing a predetermined message on the at least one note sheet; and assigning the agent to attach the adhesive to a portion of an object of each potential customer, wherein the portion of the object is prominently located.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a rear exploded view of an exemplary embodiment of the present invention;

FIG. 3 is a section view of an exemplary embodiment of the present invention, taken along line 4-4 in FIG. 1;

FIG. 4 is a perspective view of an exemplary embodiment of the present invention;

FIG. 5 is a perspective view of an exemplary embodiment of the present invention;

FIG. 6 is a section view of an exemplary embodiment of the present invention, taken along line 6-6 in FIG. 5;

FIG. 7 is a rear exploded view of an exemplary embodiment of the present invention; and

FIG. 8 is a rear exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for advertising using removably attachable note sheets that facilitate acknowledgement of the message contained thereon. The note sheets may have at least one predetermined messages affixed thereto or be blank so that a user may spontaneously affix at least one desired message thereto, whereby the user may present potential consumers with the note sheets in such a manner and with such a message so as to encourage interaction with and acknowledgement of the at least one message by the potential consumer.

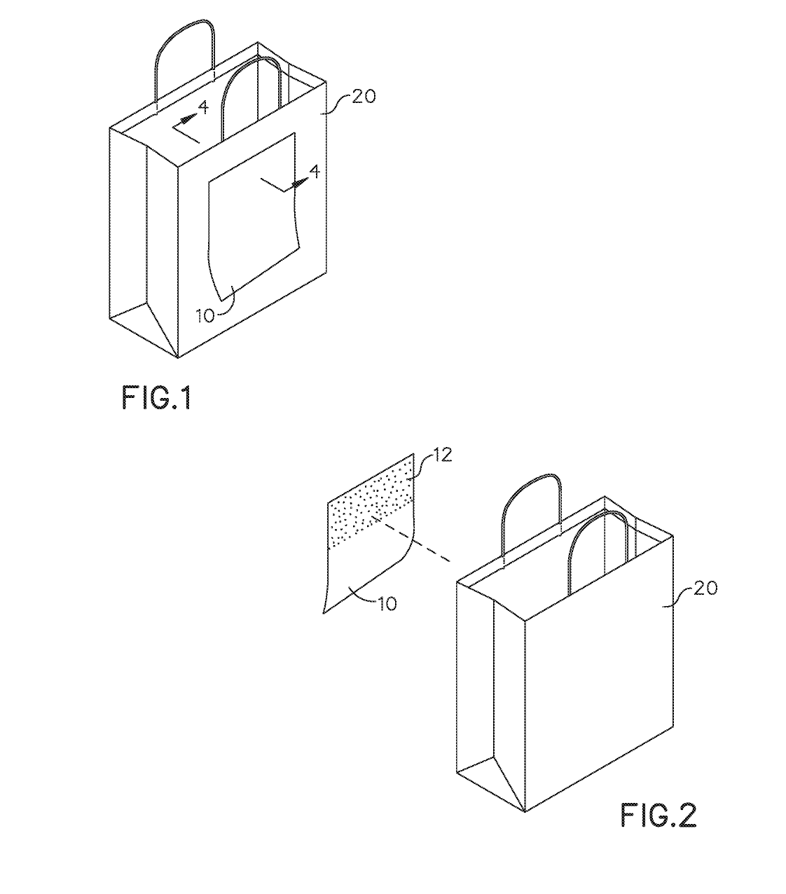

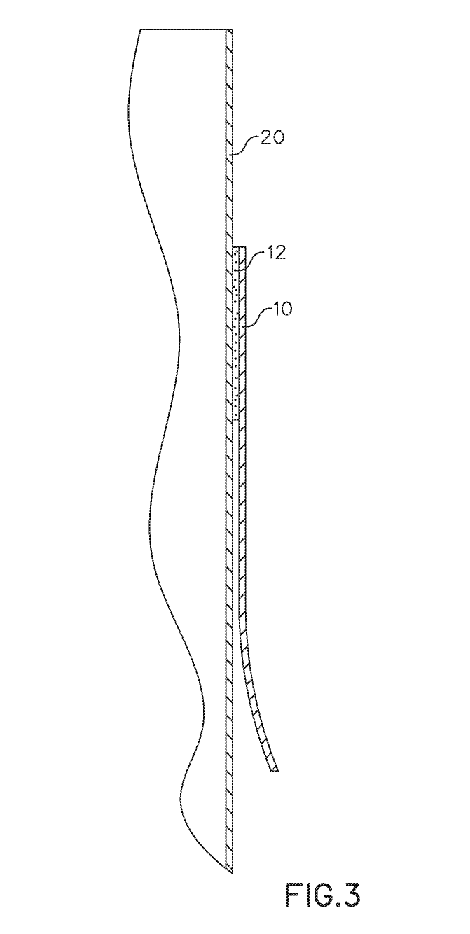

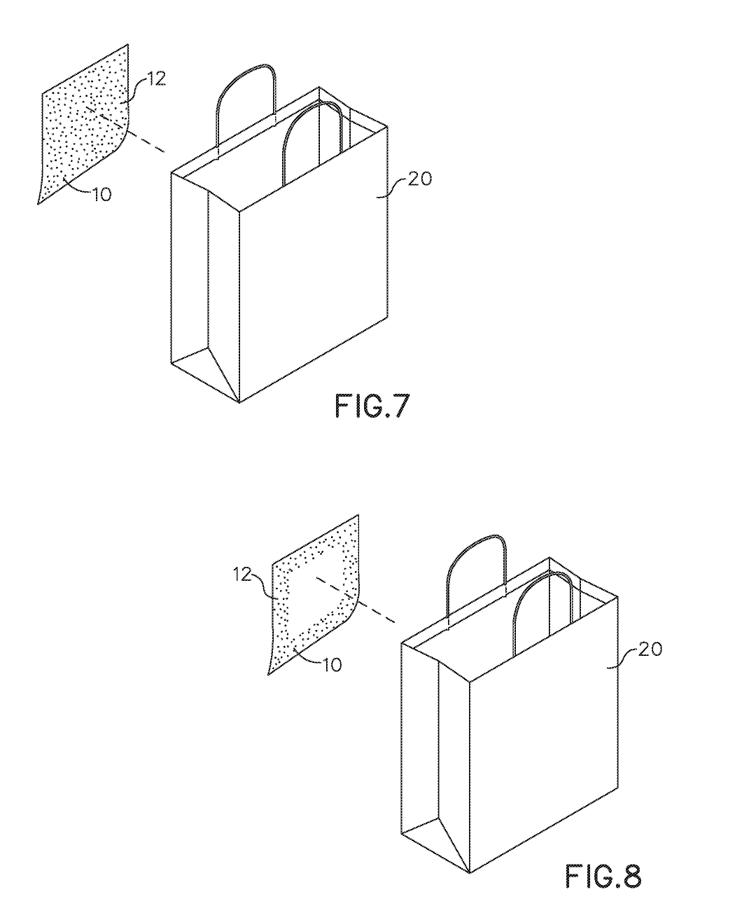

FIGS. 1 through 8 illustrate an advertising system 30 embodied in a method of the present invention for advertising using removably attachable notes that facilitates acknowledgement of the message contained thereon. The advertising system 30 may include at least one note sheet 10, a note pad 14, and a dispenser 16. Each note sheet 10 may have an adhesive 12 disposed on a portion thereof. The adhesive 12, may be integrally formed into the portion each note sheet 10, a deposit of a bonding agent, a separate layer, such as two-sided tape, or the like, wherein the adhesive 12 may be adapted to removably attach each note sheet 10 to various objects 20, as illustrated in FIGS. 1 through 3 and 7 and 8. The object 20 may be a bag, packaging, or any other object sufficient to carry the adhered-to at least one note sheet 10.

In certain embodiments the adhesive 12 is a water-based, food-safe iterative adhesive. The iterative adhesive 12 is adapted to be repeatedly applied and reapplied to successive objects 20. The iterative adhesive 12 may include acrylic homopolymers. Iterative adhesive 12 is distinguishable from repositionable adhesive, where repositionable adhesive are repositionable in terms of being sufficiently operative only when positioned from their initial backing to a first object only. Thereafter, repositionable adhesive loses sufficient operative adhesiveness to reliably remain adhered to a second object. This untrustworthiness stands athwart the method of advertising of the present invention, which teaches how to constantly promote, remind, interact with and demand the acknowledgment of a potential customer.

The iterative adhesive 12 is adapted to sufficiently removably attach the same note sheet 10 from a first object 20, so as to be initially removably attached thereto, and be removed and effectively re-attached to a second object 20 so as to be removably attached thereto to be effectively re-attached to a third object. Iterative adhesive 12 is adapted to repeatedly removably adhere to paper, paper-products, fabrics such as leather, cloth, polymers and the like.

By way of example only, a seller of handbag shop may adhere—via the iterative adhesive 12—a note sheet 10 to a to-go bag, i.e., shopping/gift/carry-out bag, (first object 20) of a paying customer of a sold handbag. Wherein the note sheet 10 provides a predetermined message informing the paying customer that if they walk into said handbag shop with said note sheet 10 adhered to said sold handbag (second object 20) they receive a discount accessories to said sold handbag. Iterative adhesive 12 facilitates such repeated application and thus the advertising method of the present invention, while mere repositionable adhesive does not.

Each note sheet 10 may be a substrate of material suitable for affixing at least one message thereon by using known forms of written or printable communication. The material substrate may include but not limited to various forms of paper products. The material substrate may be any size, shape or dimensions so long as the material substrate/note sheet 10 functions in accordance with the present invention as described herein. Each message may include but not be limited to any information desired to be imparted, such as an advertisement, a coupon, a display, a logo, trademark, slogan, contractual offer, promotional information, general information, and the like.

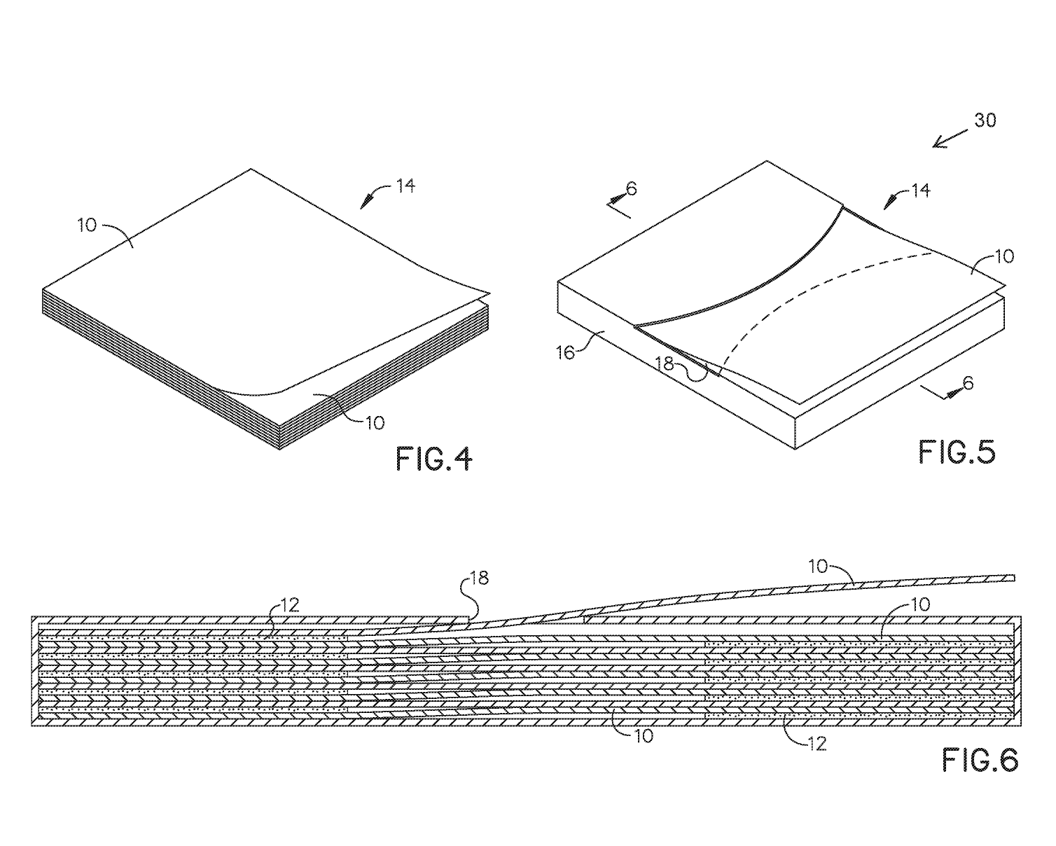

Each note sheet 10 may be removably bound together in the note pad 14, as illustrated in FIGS. 4 and 6. Each note pad 14 may be removably housed in a dispenser 16 providing a dispensing opening 18 dimensioned and adapted to receive each note sheet 10 when being dispensed, as illustrated in FIG. 5. Moreover, the dispensing opening 18 and the note pad 14 may cooperate so that when the upper most note sheet 10 is removed from the note pad 14, through the dispensing opening 18, a portion of the adjacent note sheet 10 is readily accessible through the same dispensing opening 18. In certain embodiments, the sheets 10 may be interleaved and the adhesive 12 disposed so that the portion of the adjacent note sheet 10 may protrude through the dispensing opening 18, much like a paper towel in a paper towel dispenser.

The method of using the present invention may include the following. Providing the advertising system 30 disclosed above. A user may identify a potential customer and, after removing a predetermined note sheet 10 from its note pad 14, removably attach the predetermined note sheet 10 to a prominent portion of an object 20 of the potential customer, such as the bag used for their most recent purchase. The predetermined note sheet 10 may either have a predetermined message already affixed thereon or the user may spontaneously affix a desired message thereto.

By way of example, the method may include employees or agents of a retail store who are each given at least one note sheet 10 with at least one predetermined message affixed thereto and/or at least one blank note sheet 10 for spontaneously affixing desired messages thereto. In furtherance of the example, a store may give their point-of-sale employees (e.g., cashiers) a plurality of note sheets 10 having sales-related messages, such as messaging “thanks for shopping with us,” coupons, or the like, that they removably attach to the packaging of each customer's purchase. Meanwhile, across the store at the entrance, employees (e.g., greeters) may have note sheets 10 affixed with messages related to welcoming a potential customer, such messaging “welcome,” coupons, or the like, wherein such greeters may removably attach such note sheets 10 to the clothing or other articles of the entering customer. The abovementioned note sheets 10 could be carried around in bounded note pads 14 as well as housed in at least one dispenser 16 for portable, efficient use.

The method also contemplates removably attaching each note sheet 10 in meaningful location, whereby the potential customer is encouraged to interact and acknowledge the message. For example, the note sheet 10 may be disposed on a side of a to-go bag, as illustrated FIG. 1. Moreover, the note sheet 10 could be removably attached to the handles (first object 20) of the same to-go bag, so that the customer has to acknowledge it in order to carry out the to-go bag. Moreover, the method contemplates using more than one note sheet 10 to convey one or more messages. For example, where there is a note sheet 10 on the side (concomitant object) and the handles of the to-go bag, a message on the side note sheet 10 may reference the handle note sheet 10 in conveying its message. In one instance, the handle note sheet 10 message may say, “if you find my ‘side-kick’, you get 50% off your next purchase if you bring us both in.” In such a manner, a third message may be formed (only) by combining the first and second predetermined message, thereby the third message enables an incentive to the potential customer—further facilitating the acknowledgment and affirmation of the advertising in the potential customer.

It should be understood, of course, that the foregoing relates to exemplary embodiments of the invention and that modifications may be made without departing from the spirit and scope of the invention as set forth in the following claims.

What is claimed is:

1. A method for advertising so as to facilitate interaction and acknowledgement by a potential customer, comprising:
providing at least one note sheet having an iterative adhesive disposed along a portion thereof;
affixing a predetermined message on the at least one note sheet; and
attaching via the iterative adhesive to a first object of the potential customer, wherein the predetermined message instructs the potential customer to re-attach the at least one note sheet via the iterative adhesive to a second object.

2. The method of claim 1, further including a note pad, wherein the at least one note sheet is removably bound to a plurality of note sheets.

3. The method of claim 1, further including a dispenser for removably housing the at least one note sheet.

4. The method of claim 2, further including a dispenser for removably housing the note pad.

5. The method of claim 1, further providing at least one second note sheet having a second message thereon; and attaching the at least one second note sheet to a concomitant object, wherein the predetermined message promotes combining said predetermined and second messages.

6. The method of claim 5, wherein the second message references the predetermined message.

7. The method of claim 6, wherein the second message combined with the predetermined message forms a third message, wherein only the third message enables an incentive to the potential customer.

8. The method of claim 1, wherein the first object is at least one handle of a to-go bag.

9. The method of claim 1, wherein the first object is an article of clothing of the potential customer.

10. The method of claim 8, wherein the second object is a previously purchased good.

11. The method of claim 1, wherein the iterative adhesive is water-based and food-safe.
